(19) United States
(12) Patent Application Publication
(10) Pub. No.: US 2023/0356722 A1
(43) Pub. Date: Nov. 9, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventor: Masato ENDO, Nogoya-shi (JP)

(21) Appl. No.: 18/185,382

(22) Filed: Mar. 17, 2023

(30) Foreign Application Priority Data
May 6, 2022 (JP) 2022-076554

(51) Int. Cl. B60W 40/09; G09B 19/16

(52) U.S. Cl. CPC B60W 40/09; G09B 19/167

(57) ABSTRACT

An information processing device includes: an acquisition unit that acquires vehicle information; an evaluation unit that performs evaluation related to driving of a specific driver based on the acquired vehicle information and whether a plurality of evaluation items is good; a reception unit that receives a selection on whether to notify the specific driver of test information regarding a predetermined test regarding driving skills that is conducted by a predetermined organization; and a control unit that performs control for preferentially displaying a specific evaluation item related to a determination item on whether the specific driver is to be subject to the predetermined test over another evaluation item other than the specific evaluation item among the plurality of evaluation items, when a result of the evaluation is displayed on a display unit and the reception unit has received a notification selection for notifying the specific driver of the test information.

### CROSS-REFERENCE TO RELATED APPLICATION

This application claims priority to Japanese Patent Application No. 2022-076554 filed on May 6, 2022, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2014-31050 (JP 2014-31050 A) discloses a driving skill diagnosis device that can provide a diagnosis result corresponding to the driving skill of a driver and can effectively use the diagnosis result.

### SUMMARY

The technology disclosed in JP 2014-31050 A can present the diagnosis result to the driver. However, it is difficult for the driver to grasp whether the driver is performing driving that can be subject to a predetermined test even when reviewing the diagnosis result.

Therefore, an object of the present disclosure is to provide an information processing device, an information processing method, and a storage medium that allow the driver to grasp whether the driver is performing driving that can be subject to a predetermined test.

An information processing device according to claim 1 includes: an acquisition unit that acquires vehicle information related to a vehicle; an evaluation unit that performs evaluation related to driving of a specific driver based on the vehicle information acquired by the acquisition unit and whether a plurality of evaluation items is good or bad, the specific driver being a driver of the vehicle and being able to be subject to a predetermined test regarding driving skills that is conducted by a predetermined organization; a reception unit that receives a selection as to whether to notify the specific driver of test information regarding the predetermined test; and a control unit that performs control for preferentially displaying a specific evaluation item related to a determination item as to whether the specific driver is to be subject to the predetermined test over another evaluation item other than the specific evaluation item among the plurality of evaluation items, when a result of the evaluation by the evaluation unit is displayed on a display unit and the reception unit has received a notification selection for notifying the specific driver of the test information.

In the information processing device according to claim 1, the acquisition unit acquires the vehicle information. The evaluation unit performs evaluation related to driving of the specific driver based on the vehicle information acquired by the acquisition unit and whether the plurality of evaluation items is good or bad. Further, the reception unit receives a selection as to whether to notify the specific driver of the test information regarding the predetermined test. When the notification selection has been received in the case where the result of the evaluation by the evaluation unit is displayed on the display unit, the control unit performs the control for preferentially displaying the specific evaluation item over the other evaluation item among the plurality of evaluation items. Accordingly, the information processing device causes the display unit to preferentially display the specific evaluation item related to the determination item as to whether the specific driver will be subject to the predetermined test, thereby allowing the specific driver to grasp whether the specific driver is performing driving that can be subject to the predetermined test.

In the information processing device according to claim 2, in claim 1, when the specific driver who is driving the vehicle is notified of the result of the evaluation by the evaluation unit and the reception unit has received the notification selection, the control unit performs control for preferentially notifying the specific driver of the specific evaluation item over the other evaluation item as the result of the evaluation.

In the information processing device according to claim 2, when the specific driver who is driving the vehicle is notified of the result of the evaluation by the evaluation unit and the reception unit has received the notification selection, the control unit performs control for preferentially notifying the specific driver of the specific evaluation item over the other evaluation item as the result of the evaluation. Accordingly, the information processing device preferentially notifies the specific driver who is driving the vehicle of the specific evaluation item, thereby allowing the specific driver who is driving to grasp whether the specific driver is performing driving that can be subject to the predetermined test.

In the information processing device according to claim 3, in claim 1 or 2, the specific driver is a driver of a predetermined age or older, and in a case where the display unit displays the result of the evaluation by the evaluation unit, even when the reception unit has not received the notification selection, when driving of the specific driver corresponding to the determination item is detected based on the vehicle information acquired by the acquisition unit, the control unit performs control for preferentially displaying the specific evaluation item over the other evaluation item.

In the information processing device according to claim 3, the specific driver is a driver of a predetermined age or older. Also, in a case where the display unit displays the result of the evaluation by the evaluation unit, even when the reception unit has not received the notification selection, when driving of the specific driver corresponding to the determination item is detected based on the vehicle information acquired by the acquisition unit, the control unit performs control for preferentially displaying the specific evaluation item over the other evaluation item. Accordingly, in the information processing device, the specific evaluation item is preferentially displayed when driving of the specific driver corresponding to the determination item is detected, thereby allowing the specific driver, who is a driver of a predetermined age or older, to grasp whether the specific driver is performing driving that can be subject to the predetermined test.

In the information processing device according to claim 4, in claim 1 or 2, the specific driver is a driver of a predetermined age or older, and in a case where the specific driver who is driving the vehicle is notified of the result of the evaluation by the evaluation unit, even when the reception unit has not received the notification selection, when driving of the specific driver corresponding to the determination item is detected based on the vehicle information acquired by the acquisition unit, the control unit performs control for preferentially notifying the specific driver of the specific evaluation item over the other evaluation item as the result of the evaluation.

In the information processing device according to claim 4, the specific driver is a driver of a predetermined age or older. Also, in a case where the result of the evaluation by the evaluation unit is notified to the specific driver who is driving the vehicle, even when the reception unit has not received the notification selection, when driving of the specific driver corresponding to the determination item is detected based on the vehicle information acquired by the acquisition unit, the control unit performs control for preferentially notifying the specific driver of the specific evaluation item over the other evaluation item as the result of the evaluation. Accordingly, in the information processing device, the specific evaluation item is preferentially notified to the specific driver who is driving the vehicle when driving by the specific driver corresponding to the determination item is detected, thereby allowing the specific driver who is a driver of a predetermined age or older to grasp whether the specific driver is performing driving that can be subject to the predetermined test during driving of the vehicle.

In an information processing method according to claim 5, a computer executes processes including: acquiring vehicle information related to a vehicle; performing evaluation related to driving of a specific driver based on the acquired vehicle information and whether a plurality of evaluation items is good or bad, the specific driver being a driver of the vehicle and being able to be subject to a predetermined test regarding driving skills that is conducted by a predetermined organization; receiving a selection as to whether to notify the specific driver of test information regarding the predetermined test; and performing control for preferentially displaying a specific evaluation item related to a determination item as to whether the specific driver is to be subject to the predetermined test over another evaluation item other than the specific evaluation item among the plurality of evaluation items, when a result of the evaluation is displayed on a display unit and a notification selection for notifying the specific driver of the test information has been received.

In a storage medium according to claim 6, an information processing program causes a computer to execute processes including: acquiring vehicle information related to a vehicle; performing evaluation related to driving of a specific driver based on the acquired vehicle information and whether a plurality of evaluation items is good or bad, the specific driver being a driver of the vehicle and being able to be subject to a predetermined test regarding driving skills that is conducted by a predetermined organization; receiving a selection as to whether to notify the specific driver of test information regarding the predetermined test; and performing control for preferentially displaying a specific evaluation item related to a determination item as to whether the specific driver is to be subject to the predetermined test over another evaluation item other than the specific evaluation item among the plurality of evaluation items, when a result of the evaluation is displayed on a display unit and a notification selection for notifying the specific driver of the test information has been received.

The information processing device according to claim 4 may adopt another aspect described below.

As another aspect, in the information processing device according to claim 4, in any one of claims 1 to 3, the specific driver is a driver of a predetermined age or older, and in a case where the specific driver who is driving the vehicle is notified of the result of the evaluation by the evaluation unit, even when the reception unit has not received the notification selection, when driving of the specific driver corresponding to the determination item is detected based on the vehicle information acquired by the acquisition unit, the control unit performs control for preferentially notifying the specific driver of the specific evaluation item over the other evaluation item as the result of the evaluation.

As described above, the information processing device, the information processing method, and the storage medium according to the present disclosure can allow the driver to grasp whether the driver is performing driving that can be subject to a predetermined test.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system according to the present embodiment;

FIG. 2 is a block diagram showing hardware configurations of a management server and a driver terminal according to the present embodiment;

FIG. 3 is a block diagram showing a configuration of a storage unit of the management server according to the present embodiment;

FIG. 4 is a block diagram showing an example of a functional configuration of the management server according to the present embodiment;

FIG. 5 is a block diagram showing a hardware configuration of a vehicle according to the present embodiment;

FIG. 6 is a flowchart showing a flow of a display process executed by the management server according to the present embodiment;

FIG. 7 is a first display example displayed on a display unit of the driver terminal according to the present embodiment;

FIG. 8 is a second display example displayed on the display unit of the driver terminal according to the present embodiment;

FIG. 9 is a third display example displayed on the display unit of the driver terminal according to the present embodiment;

FIG. 10 is a fourth display example displayed on the display unit of the driver terminal according to the present embodiment;

FIG. 11 is a fifth display example displayed on the display unit of the driver terminal according to the present embodiment;

FIG. 12 is a sixth display example displayed on the display unit of the driver terminal according to the present embodiment;

FIG. 13 is a seventh display example displayed on the display unit of the driver terminal according to the present embodiment;

FIG. 14 is an eighth display example displayed on the display unit of the driver terminal according to the present embodiment;

FIG. 15A is an explanatory diagram showing a display example in a multi-information display (MID) according to the present embodiment;

FIG. 15B is an explanatory diagram showing a display example in the MID according to the present embodiment;

FIG. 16 is a first display example displayed on the MID while driving the vehicle according to the present embodiment; and

FIG. 17 is a second display example displayed on the MID while driving the vehicle according to the present embodiment.

### DETAILED DESCRIPTION OF EMBODIMENTS

Hereinafter, an information processing system 10 according to the present embodiment will be described.

The information processing system 10 according to the present embodiment is a system that allows a driver to grasp whether the driver is performing driving that can be subject to a driving skill test.

The driving skill test is an obligatory test for drivers who have committed certain violations in the past three years from the starting date (160 days before the birthday closest to the license expiration date). Examples of the above-mentioned certain violations include ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, and use of mobile phones, etc.

Ignoring traffic lights is, for example, a violation of entering an intersection on a red light.

The violation of traffic divisions is, for example, a violation such as straying into the opposite lane or driving in the wrong direction.

The violation of traffic lanes, etc. is, for example, a violation of continuing to proceed in the overtaking lane, or a violation of not leaving the priority lane when a route bus or the like is approaching.

Speeding is, for example, a violation of driving above the maximum speed limit.

The crossing prohibition violations include legal crossing prohibition violations and designated crossing prohibition violations. The legal crossing prohibition violation is, for example, a violation of crossing, turning, or backing up when there is a risk of obstructing the traffic of other vehicles and the like. The designated crossing prohibition violation is, for example, a violation of performing any one of crossing, turning, or backing up at a place where crossing, turning, or backing up is prohibited by road signs or the like.

Non-stopping at railroad crossings/entering blocked railroad crossings is, for example, a violation such as passing through a railroad crossing without stopping immediately before the railroad crossing, or entering a railroad crossing when the gate is about to close or the like.

The violation of right and left turn methods at intersections, etc. includes a violation of right and left turn methods at intersections and a violation of a left turn method at roundabouts. The violation of right and left turn methods at intersections is, for example, a violation of not moving to the left edge of the road before turning left. The violation of a left turn method at roundabouts is, for example, a violation of not moving to the left edge of the road before turning right or left at a roundabout.

The violation of the obligation to proceed safely at intersections, etc. includes obstruction of priority vehicles at intersections, obstruction of traffic on priority roads, etc., a violation of the obligation to proceed safely at intersections, obstruction of traffic at roundabouts, etc., and a violation of the obligation to proceed safely at roundabouts. The obstruction of priority vehicles at intersections is, for example, a violation such as obstructing the progress of a vehicle proceeding from the left at an intersection without traffic lights. The obstruction of traffic on priority roads, etc. is, for example, a violation such as obstructing the progress of a vehicle passing through a priority road at an intersection without traffic lights. The violation of the obligation to proceed safely at intersections is, for example, a violation such as not confirming safety when entering or passing through an intersection. The obstruction of traffic at roundabouts, etc. is, for example, a violation such as obstructing the progress of a vehicle passing through a roundabout. The violation of the obligation to proceed safely at roundabouts is, for example, a violation such as not confirming safety when entering or passing through a roundabout.

The obstruction of pedestrians crossing the road, etc. is, for example, a violation such as obstructing a pedestrian crossing a pedestrian crossing.

The violation of the obligation to drive safely is, for example, a violation such as not paying attention ahead or not confirming safety.

The use of mobile phones, etc. is, for example, a violation such as driving while holding a mobile phone and talking.

The above-mentioned driving skill test is administered by a predetermined organization (for example, the Metropolitan Police Department) that is different from the manufacturer that manufactures the vehicles and the dealer that sells the vehicles. The driving skill test is an example of a “predetermined test regarding driving skills”.

### First Embodiment

First, a first embodiment of the information processing system 10 according to the present embodiment will be described.

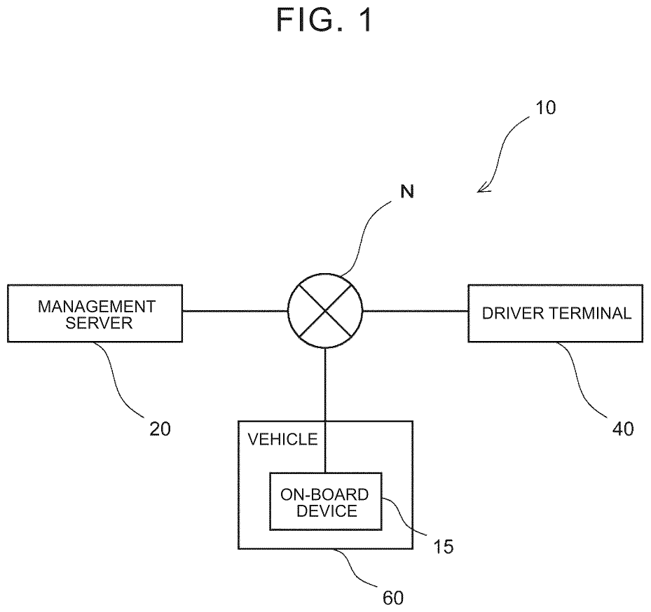

FIG. 1 is a diagram showing a schematic configuration of the information processing system 10.

As shown in FIG. 1, the information processing system 10 includes a management server 20, a driver terminal 40, and a vehicle 60. The management server 20, the driver terminal 40, and an on-board device 15 mounted on the vehicle 60 are connected via a network N, and are able to communicate with each other.

The management server 20 is a server computer owned by a predetermined business operator. The management server 20 is an example of an “information processing device”.

The driver terminal 40 is a mobile terminal owned by the driver of the vehicle 60. As an example, a portable personal computer (laptop PC), a smartphone, a tablet terminal, or the like is applied to the driver terminal 40. In the first embodiment, as an example, the driver terminal 40 is a smartphone.

The vehicle 60 may be an engine vehicle, a hybrid electric vehicle, or a battery electric vehicle. However, in the first embodiment, the vehicle 60 is an engine vehicle as an example.

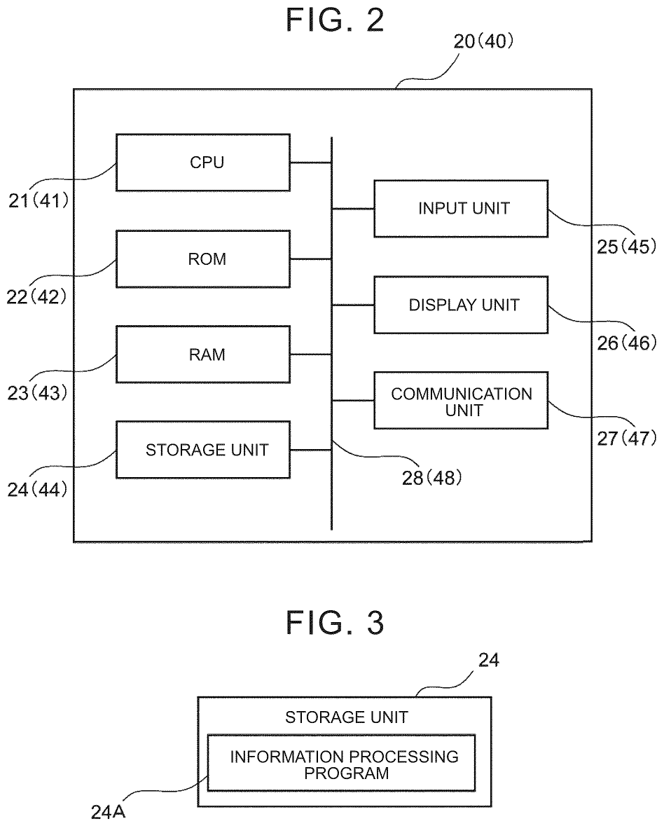

Next, hardware configurations of the management server 20 and the driver terminal 40 will be described. FIG. 2 is a block diagram showing the hardware configurations of the management server 20 and the driver terminal 40. Since the management server 20 and the driver terminal 40 basically have general computer configurations, the management server 20 will be described as a representative.

As shown in FIG. 2, the management server 20 includes a central processing unit (CPU) 21, a read-only memory (ROM) 22, a random access memory (RAM) 23, a storage unit 24, an input unit 25, a display unit 26, and a communication unit 27. The configurations are communicably connected to each other via a bus 28.

The CPU 21 is a central processing unit that executes various programs and that controls various units. That is, the CPU 21 reads the program from the ROM 22 or the storage unit 24 and executes the program using the RAM 23 as a work area. The CPU 21 controls each of the above configurations and performs various arithmetic processes in accordance with the program recorded in the ROM 22 or the storage unit 24.

The ROM 22 stores various programs and various data. The RAM 23 temporarily stores a program or data as a work area.

The storage unit 24 is composed of a storage device such as a hard disk drive (HDD), a solid state drive (SSD), or a flash memory, and stores various programs and various data. The storage unit 24 is an example of a storage medium.

The input unit 25 includes a pointing device such as a mouse, a keyboard, a microphone, a camera, and the like, and is used for performing various inputs.

The display unit 26 is, for example, a liquid crystal display and displays various types of information. A touch panel may be adopted as the display unit 26 and may function as the input unit 25.

The communication unit 27 is an interface for communicating with other devices. For the communication, for example, a wired communication standard such as Ethernet (registered trademark) or FDDI, or a wireless communication standard such as 4G, 5G, Bluetooth (registered trademark), or Wi-Fi (registered trademark) is used.

FIG. 3 is a block diagram showing a configuration of the storage unit 24 of the management server 20.

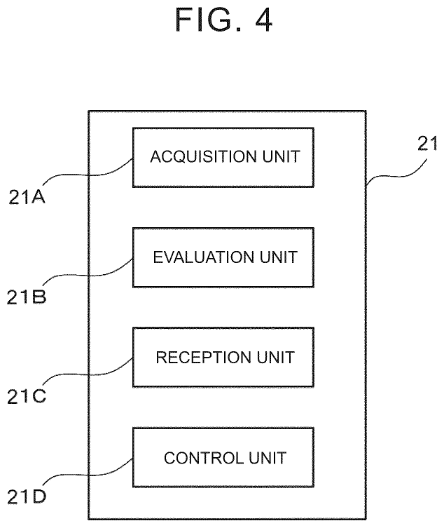

As shown in FIG. 3, the storage unit 24 stores an information processing program 24A for causing the CPU 21 of the management server 20 to function as a functional configuration shown in FIG. 4, which will be described later. When executing the information processing program 24A, the management server 20 executes the processes based on the information processing program 24A using hardware resources shown in FIG. 2.

Next, a functional configuration of the management server 20 will be described.

FIG. 4 is a block diagram showing an example of the functional configuration of the management server 20.

As shown in FIG. 4, the CPU 21 of the management server 20 has, as functional configurations, an acquisition unit 21A, an evaluation unit 21B, a reception unit 21C, and a control unit 21D. Each functional configuration is realized when the CPU 21 reads and executes the information processing program 24A stored in the storage unit 24.

The acquisition unit 21A acquires vehicle information regarding the vehicle 60. For example, the acquisition unit 21A acquires, as the vehicle information, a steering angle, an acceleration, a vehicle speed, and a turn signal operation of the vehicle 60 respectively detected by a steering angle sensor 71, an acceleration sensor 72, a vehicle speed sensor 73, and a turn signal switch 74 (to be described later) that are included in the vehicle 60. The acquisition unit 21A also acquires, as the vehicle information, the engine speed, engine torque, fuel consumption, and accelerator operation of the vehicle 60 detected by an electronic control unit (ECU) 70C (to be described later) included in the vehicle 60. The acquisition unit 21A also acquires, as the vehicle information, an image captured by a camera 76 (to be described later) included in the vehicle 60. The above information is part of the vehicle information that can be acquired by the acquisition unit 21A from the vehicle 60, and the acquisition unit 21A can also acquire information regarding the vehicle 60 other than the above information from the vehicle 60 as the vehicle information.

Based on the vehicle information acquired by the acquisition unit 21A and whether a plurality of evaluation items are good or bad, the evaluation unit 21B evaluates the driving of a specific driver who is the driver of the vehicle 60 and who can be subject to the driving skill test (hereinafter referred to as “driving diagnosis”). The specific driver is a driver of a predetermined age, for example, 72 years old or older, and is a so-called elderly driver.

In the first embodiment, the plurality of evaluation items includes acceleration, steering, braking, and eco-friendliness as an example. In the first embodiment, the evaluation unit 21B calculates an individual evaluation value for each item in the plurality of evaluation items based on the vehicle information, and sums the calculated individual evaluation values for each item to calculate a total evaluation value. For example, based on the vehicle information, the evaluation unit 21B calculates the individual evaluation value of the evaluation item “braking” from braking operations such as a sudden braking and the presence or absence of a temporary stop. Then, the evaluation unit 21B calculates the individual evaluation value of each item in the plurality of evaluation items and the total evaluation value as the result of the driving diagnosis for the specific driver (hereinafter referred to as “driving diagnosis result”).

The reception unit 21C receives a selection as to whether to notify the specific driver of test information related to the driving skill test. For example, the reception unit 21C receives the information of notifying the specific driver of the test information when an application that is installed in the driver terminal 40 and indicates the driving diagnosis result of the specific driver (hereinafter referred to as a “driving diagnosis app”) is executed and a predetermined operation is executed on the driving diagnosis app.

The control unit 21D generates content information indicating content to be displayed on the display unit 46 of the driver terminal 40 as the driving diagnosis result. In the first embodiment, the display unit 46 of the driver terminal 40 is an example of the “display unit”.

Here, in the case where the driving diagnosis result is displayed on the display unit 46 of the driver terminal 40, when the reception unit 21C has received a notification selection for notifying the specific driver of the test information, the control unit 21D performs control for preferentially displaying a specific evaluation item related to a determination item as to whether the driver is subject to the driving skill test over other evaluation items other than the specific evaluation item among the plurality of evaluation items. In this case, the control unit 21D generates content information in which the specific evaluation item is preferentially displayed over other evaluation items among the plurality of evaluation items. The determination item is the above-mentioned certain violation such as ignoring traffic lights and the violation of traffic divisions.

Preferentially displaying the specific evaluation item includes, for example, displaying the specific evaluation item at a conspicuous position (e.g., upper portion) of the display unit 46, displaying only the specific evaluation item on the display unit 46, emphasizing the specific evaluation item by differentiating at least one of the character color and character size of the specific evaluation item and other evaluation items, emphasizing the specific evaluation item by enclosing the specific evaluation item with a frame, and the like. A display example in which the specific evaluation item is preferentially displayed on the display unit 46 over other evaluation items will be described later.

Further, in the first embodiment, the specific evaluation items are acceleration, steering, and braking, which are evaluation items for driving operations related to the above-described certain violations. In this case, in the first embodiment, the other evaluation item is eco-friendliness.

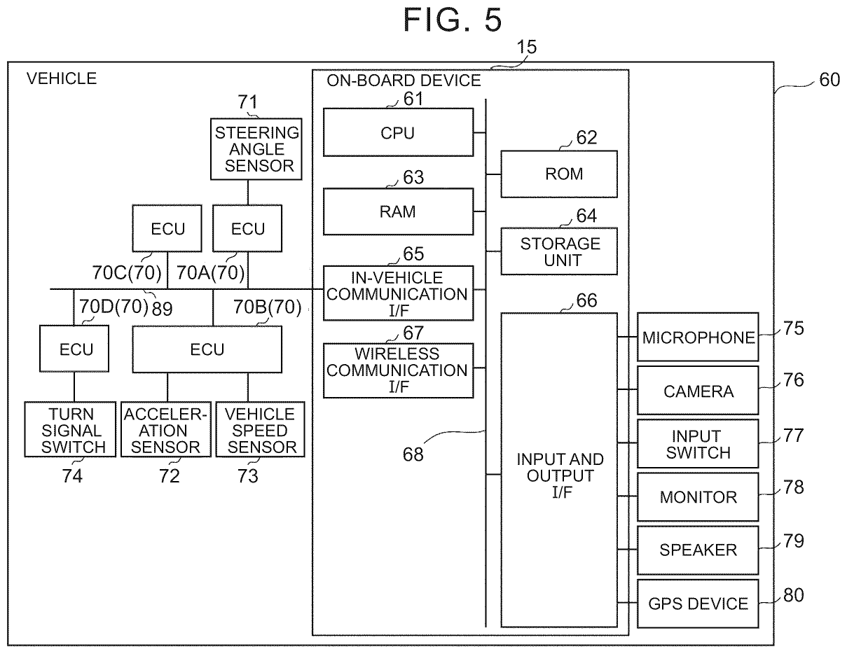

Next, the hardware configuration of the vehicle 60 will be described. FIG. 5 is a block diagram showing the hardware configuration of the vehicle 60.

As shown in FIG. 5, the vehicle 60 includes the on-board device 15, a plurality of ECUs 70, the steering angle sensor 71, the acceleration sensor 72, the vehicle speed sensor 73, the turn signal switch 74, a microphone 75, the camera 76, an input switch 77, a monitor 78, a speaker 79, and a global positioning system (GPS) device 80.

The on-board device 15 includes a CPU 61, a ROM 62, a RAM 63, a storage unit 64, an in-vehicle communication interface (I/F) 65, an input and output I/F 66, and a wireless communication I/F 67. The CPU 61, the ROM 62, the RAM 63, the storage unit 64, the in-vehicle communication I/F 65, the input and output I/F 66, and the wireless communication I/F 67 are connected to each other so as to be communicable with each other via an internal bus 68.

The CPU 61 is a central processing unit that executes various programs and that controls various units. That is, the CPU 61 reads the program from the ROM 62 or the storage unit 64 and executes the program using the RAM 63 as a work area. The CPU 61 controls each of the above configurations and performs various arithmetic processes in accordance with the program recorded in the ROM 62 or the storage unit 64.

The ROM 62 stores various programs and various data. The RAM 63 temporarily stores a program or data as a work area.

The storage unit 64 is composed of a storage device such as an embedded Multi-Media Card (eMMC) or a universal flash storage (UFS), and stores various programs and various data.

The in-vehicle communication I/F 65 is an interface for connecting to the ECUs 70. For the interface, a communication standard based on a controller area network (CAN) protocol is used. The in-vehicle communication I/F 65 is connected to an external bus 89.

The ECUs 70 are provided for respective functions of the vehicle 60, and in the first embodiment, an ECU 70A, an ECU 70B, the ECU 70C, and an ECU 70D are provided. The ECU 70A is exemplified by an electric power steering ECU, and the steering angle sensor 71 is connected to the ECU 70A. The ECU 70B is exemplified by a vehicle stability control (VSC) ECU, and the acceleration sensor 72 and the vehicle speed sensor 73 are connected to the ECU 70B. In addition to the acceleration sensor 72 and the vehicle speed sensor 73, a yaw rate sensor may be connected to the ECU 70B.

The ECU 70C is exemplified by an engine ECU, and detects the engine speed and engine torque of the vehicle 60 to control the engine. The ECU 70C detects fuel consumption based on a fuel flow rate acquired from sensors (not shown). Further, the ECU 70C detects the accelerator operation of the vehicle 60. The engine speed, engine torque, fuel consumption, and accelerator operation detected by the ECU 70C are stored in the storage unit 64 and transmitted to the management server 20 as the vehicle information. The ECU 70D is exemplified by a steering ECU, and the turn signal switch 74 is connected to the ECU 70D. The turn signal switch 74 is provided on the steering column for operating the turn signal. The ECU 70D detects the operation of the turn signal switch 74 by the driver as the turn signal operation. The turn signal operation detected by the ECU 70D is stored in the storage unit 64 and transmitted to the management server 20 as the vehicle information.

The steering angle sensor 71 is a sensor for detecting the steering angle of the steering wheel. The steering angle detected by the steering angle sensor 71 is stored in the storage unit 64 and transmitted to the management server 20 as the vehicle information.

The acceleration sensor 72 is a sensor for detecting the acceleration acting on the vehicle 60. The acceleration sensor 72 is, for example, a three-axis acceleration sensor that detects the acceleration applied in the vehicle front-rear direction as the X-axis direction, the vehicle width direction as the Y-axis direction, and the vehicle height direction as the Z-axis direction. The acceleration detected by the acceleration sensor 72 is stored in the storage unit 64 and transmitted to the management server 20 as the vehicle information.

The vehicle speed sensor 73 is a sensor for detecting a vehicle speed of the vehicle 60. The vehicle speed sensor 73 is, for example, a sensor provided on a vehicle wheel. The vehicle speed detected by the vehicle speed sensor 73 is stored in the storage unit 64 and transmitted to the management server 20 as the vehicle information.

The input and output I/F 66 is an interface for communicating with the microphone 75, the camera 76, the input switch 77, the monitor 78, the speaker 79, and the GPS device 80 mounted on the vehicle 60.

The microphone 75 is a device provided on the front pillar, a dashboard, or the like of the vehicle 60, and collects voices emitted by the driver of the vehicle 60. The microphone 75 may be provided in the camera 76 that will be described later.

The camera 76 is, for example, an imaging device that performs imaging using an imaging element such as a charge coupled device (CCD) image sensor or a complementary metal oxide semiconductor (CMOS) image sensor. The camera 76 includes, for example, a first camera provided in the front part of the vehicle 60 for imaging ahead of the vehicle, and a second camera provided in the upper part of the windshield or the dashboard of the vehicle 60 and directed to the specific driver. The image captured by the first camera of the camera 76 is used, for example, for recognizing the inter-vehicle distance from the preceding vehicle traveling ahead of the vehicle 60, the lanes, the traffic lights, and the like. The image captured by the second camera of the camera 76 is used, for example, for recognizing the state of the specific driver. The image captured by the camera 76 is stored in the storage unit 64 and transmitted to the management server 20 as the vehicle information. Note that the camera 76 may be configured as an imaging device for other uses such as a drive recorder and an advanced driver assistance system (ADAS). Further, the camera 76 may be connected to the on-board device 15 via the ECU 70 (for example, a camera ECU).

The input switch 77 is provided on the instrument panel, the center console, the steering wheel, or the like, and is a switch for inputting an operation by fingers of the driver. As the input switch 77, for example, a push button type numeric keypad, a touch pad, or the like can be adopted.

The monitor 78 is a liquid crystal monitor provided on an instrument panel, an instrument cluster, or the like, for displaying an image of an operation proposal related to a function of the vehicle 60 and an explanation of the function. The monitor 78 may be provided as a touch panel that also serves as the input switch 77.

The speaker 79 is a device provided on an instrument panel, a center console, a front pillar, a dashboard, or the like, for outputting a voice for an operation proposal related to a function of the vehicle 60 and an explanation of the function. The speaker 79 may be provided on the monitor 78.

The GPS device 80 is a device that measures the current position of the vehicle 60. The GPS device 80 includes an antenna (not shown) that receives signals from GPS satellites. Note that, the GPS device 80 may be connected to the on-board device 15 via a car navigation system connected to the ECU 70 (for example, a multimedia ECU).

The wireless communication I/F 67 is a wireless communication module for communicating with the management server 20. For the wireless communication module, for example, communication standards such as 5G, long term evolution (LTE), and Wi-Fi (registered trademark) are used. The wireless communication I/F 67 is connected to the network N.

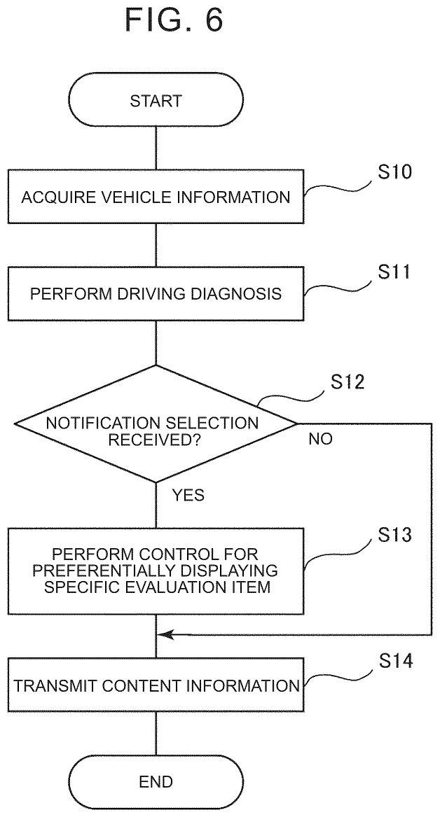

FIG. 6 is a flowchart showing a flow of a display process for displaying the driving diagnosis result of the specific driver by the management server 20 on the display unit 46 of the driver terminal 40. The display process is executed when the CPU 21 reads the information processing program 24A from the storage unit 24, expands the information processing program 24A into the RAM 23, and executes the program.

In step S10 shown in FIG. 6, the CPU 21 acquires the vehicle information from the vehicle 60. Then, the process proceeds to step S11. In the first embodiment, as an example, the vehicle information is periodically transmitted from the vehicle 60 to the management server 20.

In step S11, the CPU 21 performs the driving diagnosis of the specific driver based on the vehicle information acquired in step S10. As an example, the CPU 21 calculates the individual evaluation value of each item in the plurality of evaluation items and the total evaluation value of the specific driver based on the vehicle information. Then, the process proceeds to step S12.

In step S12, the CPU 21 determines whether the notification selection has been received. When the CPU 21 determines that the notification selection has been received (step S12: YES), the process proceeds to step S13. On the other hand, when the CPU 21 determines that the notification selection has not been received (step S12: NO), the process proceeds to step S14.

In step S13, the CPU 21 performs control to preferentially display a specific evaluation item over other evaluation items. As an example, the CPU 21 determines a preferential display method for a specific evaluation item (for example, enclosing the specific evaluation item with a frame) based on predetermined settings. Then, the process proceeds to step S14.

In step S14, the CPU 21 generates content information including the individual evaluation value and the total evaluation value calculated in step S11 and transmits the generated content information to the driver terminal 40. Then, the display process ends. When proceeding from step S13 to step S14, the CPU 21 generates the content information in which the specific evaluation item is displayed by the preferential display method determined in step S13.

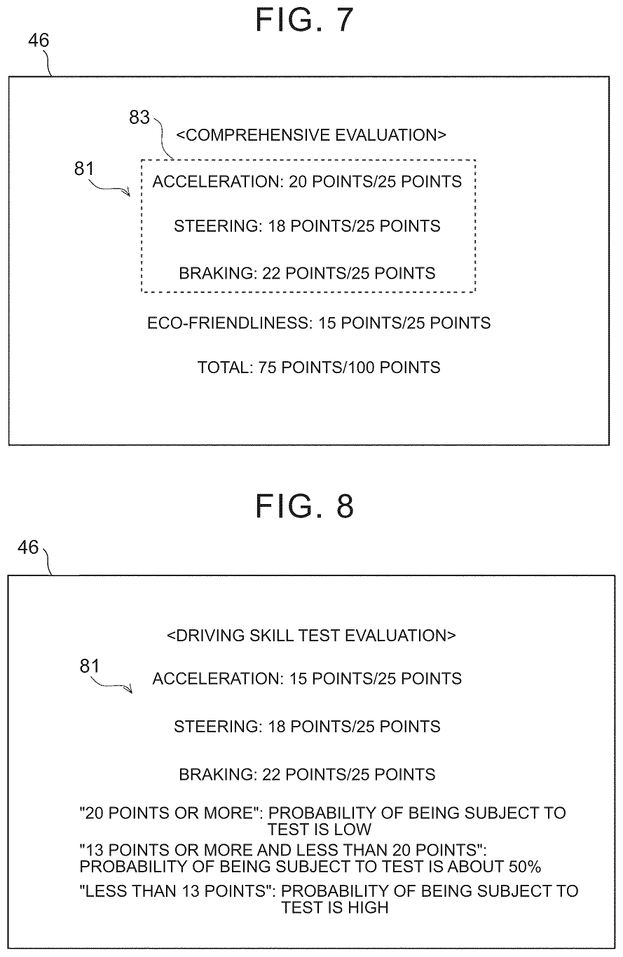

Next, a display example displayed on the display unit 46 of the driver terminal 40 as a result of the display process shown in FIG. 6 being performed by the management server 20 will be described. The display examples shown in FIGS. 7 and 8 described below are display examples when the CPU 21 has received the notification selection.

FIG. 7 shows a first display example displayed on the display unit 46 of the driver terminal 40. When the driving diagnosis app is executed in the driver terminal 40, the CPU 21 of the management server 20 causes the display unit 46 to display the display example shown in FIG. 7 as a home screen that is first displayed after the driving diagnosis app is executed.

In the display example shown in FIG. 7, message information 81 and an emphasizing frame 83 are displayed. Note that the message information 81 and the emphasizing frame 83 are contents displayed based on the content information transmitted from the management server 20.

The message information 81 indicates various messages for the specific driver. As an example, in FIG. 7, “<Comprehensive evaluation> Acceleration: 20 points/25 points, Steering: 18 points/25 points, Braking: 22 points/25 points, Eco-friendliness: 15 points/25 points, and Total: 75 points/100 points” are displayed as the message information 81. In this way, the message information 81 shown in FIG. 7 indicates the individual evaluation value of each item in the plurality of evaluation items and the total evaluation value obtained by summing the individual evaluation values of each item.

The emphasizing frame 83 is a frame for emphasizing the specific evaluation item. As described above, in the first embodiment, the specific evaluation items are acceleration, steering, and braking. As a result, in the display example shown in FIG. 7, as an example of preferentially displaying the specific evaluation item, the portion indicating the individual evaluation values of the acceleration, the steering, and the braking in the message indicated by the message information 81 is surrounded by the emphasizing frame 83. In the display example shown in FIG. 7, the portion of the message indicated by the message information 81 surrounded by the emphasizing frame 83 serves as the test information related to the driving skill test.

Preferentially displaying the specific evaluation item is not limited to emphasizing the specific evaluation item with the emphasizing frame 83, and other configurations described above may be employed. Hereinafter, FIG. 8 will be described as an example.

FIG. 8 shows a second display example displayed on the display unit 46 of the driver terminal 40. The display example shown in FIG. 8 is a home screen that is first displayed after the driving diagnosis app is executed, like the display example shown in FIG. 7, but the content displayed on the home screen is different.

In the display example shown in FIG. 8, the message information 81 is displayed. Note that the message information 81 is content displayed based on the content information transmitted from the management server 20.

As an example, in FIG. 8, “<Driving skill test evaluation> Acceleration: 15 points/25 points, Steering: 18 points/25 points, Braking: 22 points/25 points, “20 points or more”: probability of being subject to test is low, “13 points or more and less than 20 points”: probability of being subject to test is about 50%, and “Less than 13 points”: probability of being subject to test is high” are displayed as the message information 81. As described above, in the message information 81 shown in FIG. 8, only the messages related to the specific evaluation items are displayed on the display unit 46 as an example of preferentially displaying the specific evaluation item. Also, the message information 81 indicates the relationship between the individual evaluation values of the specific evaluation items and the probabilities of being subject to the driving skill test. As a result, the specific driver who saw the message information 81 shown in FIG. 8 can grasp that the probability of being subject to the driving skill test for the current acceleration operation and the current steering operation is about 50%, and the probability of being subject to the driving skill test for the current braking operation is low. In the display example shown in FIG. 8, the message indicated by the message information 81 serves as the test information related to the driving skill test.

Here, in the first embodiment, the CPU 21 receives the information of notifying the test information to the specific driver when a predetermined operation is performed on the driving diagnosis app. The predetermined operation is not limited, and may be, for example, a button operation on the setting screen of the driving diagnosis app, an operation for opening a screen on which the test information is displayed, or the like. The following describes the flow of displaying the test information on the display unit 46 of the driver terminal 40 when the predetermined operation is as an operation for opening the screen on which the test information is displayed.

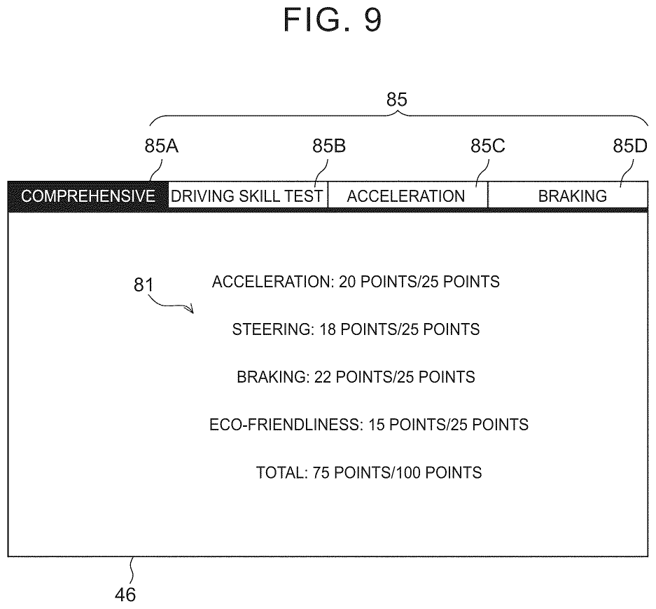

FIG. 9 shows a third display example displayed on the display unit 46 of the driver terminal 40. The display example shown in FIG. 9 is a home screen that is first displayed after the driving diagnosis app is executed, like the display examples shown in FIGS. 7 and 8, but the content displayed on the home screen is different.

In the display example shown in FIG. 9, the message information 81 and a page switching section 85 are displayed. The message indicated by the message information 81 shown in FIG. 9 has the same content as the message indicated by the message information 81 shown in FIG. 7, so the description thereof is omitted. The message information 81 and the page switching section 85 are contents displayed based on the content information transmitted from the management server 20.

Here, unlike the display examples shown in FIGS. 7 and 8, the display example shown in FIG. 9 is a display example when the CPU 21 has not received the notification selection. Therefore, in the display example shown in FIG. 9, unlike the display example shown in FIG. 7, the emphasizing frame 83 is not displayed.

The page switching section 85 is a switching tab for switching pages of the driving diagnosis app displayed on the display unit 46. The page switching section 85 has a first switching section 85A for switching the page of the driving diagnosis app to a comprehensive evaluation page displaying the comprehensive evaluation, a second switching section 85B for switching to a driving skill test evaluation page displaying the driving skill test evaluation, a third switching section 85C for switching to an acceleration evaluation page displaying the acceleration evaluation, and a fourth switching section 85D for switching to a braking evaluation page displaying the braking evaluation. In the first embodiment, a page corresponding to the first switching section 85A is displayed on the home screen. Therefore, the tab indicated by the page switching section 85 is more likely to be observed by the specific driver as the tab is located on the left side of the page switching section 85. In other words, in the page switching section 85 shown in FIG. 9, the first switching section 85A located at the left end is the most likely to be observed, and the fourth switching section 85D located at the right end is the most difficult to be observed.

The comprehensive evaluation page is, for example, a page that displays the individual evaluation value for each item in the plurality of evaluation items and the total evaluation value obtained by summing the individual evaluation values for each item of the specific driver.

The driving skill test evaluation page is, for example, a page that displays the relationship between the individual evaluation values of specific evaluation items of the specific driver and the probabilities of being subject to the driving skill test.

The acceleration evaluation page is, for example, a page that displays the individual evaluation value of the evaluation item “acceleration” of the specific driver and advice information that contributes to improving the individual evaluation value.

The braking evaluation page is, for example, a page that displays the individual evaluation value of the evaluation item “braking” of the specific driver and advice information that contributes to improving the individual evaluation value.

In the first embodiment, the display unit 46 displays a page corresponding to the page switching section 85 in which the background of the tab is black. That is, in the display example shown in FIG. 9, the comprehensive evaluation page corresponding to the first switching section 85A is displayed on the display unit 46.

In the first embodiment, when the CPU 21 receives an operation for the page switching section 85 in which the background of the tab is white, the page displayed on the display unit 46 is changed to the page corresponding to that page switching section 85.

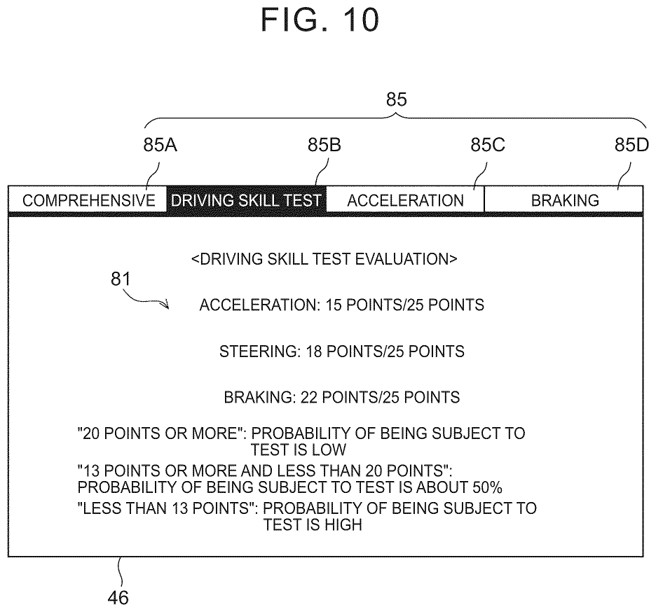

FIG. 10 shows a fourth display example displayed on the display unit 46 of the driver terminal 40. The display example shown in FIG. 10 is a display example after receiving an operation for the second switching section 85B on the home screen shown in FIG. 9.

In the display example shown in FIG. 10, the message information 81 and the page switching section 85 are displayed. The message indicated by the message information 81 shown in FIG. 10 has the same content as the message indicated by the message information 81 shown in FIG. 8, so the description thereof is omitted. The message information 81 and the page switching section 85 are contents displayed based on the content information transmitted from the management server 20. In the display example shown in FIG. 10, the message indicated by the message information 81 serves as the test information related to the driving skill test.

In this way, the CPU 21 may receive the information of notifying the specific driver of the test information based on the operation of the second switching section 85B for displaying the driving skill test evaluation page as the operation for opening the screen on which the test information is displayed.

As described above, in the management server 20, the CPU 21 acquires the vehicle information. The CPU 21 performs the driving diagnosis of the specific driver based on the acquired vehicle information and whether the plurality of evaluation items is good or bad. The CPU 21 further receives a selection as to whether to notify the specific driver of the test information related to the driving skill test. When the notification selection has been received in the case where the driving diagnosis result is displayed on the display unit 46, the CPU 21 performs the control for preferentially displaying the specific evaluation item over other evaluation items among the plurality of evaluation items. Accordingly, the management server 20 causes the display unit 46 to preferentially display the specific evaluation items related to certain violations as to whether the specific driver will be subject to the driving skill test, thereby allowing the specific driver to grasp whether the specific driver is performing driving that can be subject to the driving skill test.

### Second Embodiment

Next, a second embodiment of the information processing system 10 according to the present embodiment will be described while omitting or simplifying the overlapping portion with the other embodiments.

The second embodiment differs from the first embodiment in the plurality of evaluation items that serves as indicators for performing the driving diagnosis of the specific driver. Specifically, in the second embodiment, the plurality of evaluation items includes, for example, ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, use of mobile phones, etc., sudden braking, sudden acceleration, and sudden steering, etc. As described above, in the second embodiment, the plurality of evaluation items includes certain violations as to whether the driving will be subject to the driving skill test. The content of the evaluation items is also more specific than in the first embodiment, and the number of evaluation items is greater than in the first embodiment.

In addition, in the second embodiment, the specific evaluation items are evaluation items corresponding to the above-mentioned certain violations including ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, and use of mobile phones, etc. In this case, in the second embodiment, other evaluation items are evaluation items other than specific evaluation items such as sudden braking, sudden acceleration, and sudden steering, etc.

Next, differences from the first embodiment in the functional configuration of the management server 20 according to the second embodiment will be described.

In the second embodiment, the evaluation unit 21B counts the number of times each item in the plurality of evaluation items has been performed based on the vehicle information acquired by the acquisition unit 21A, and the driving diagnosis of the specific driver is performed based on the counted number of times for each item.

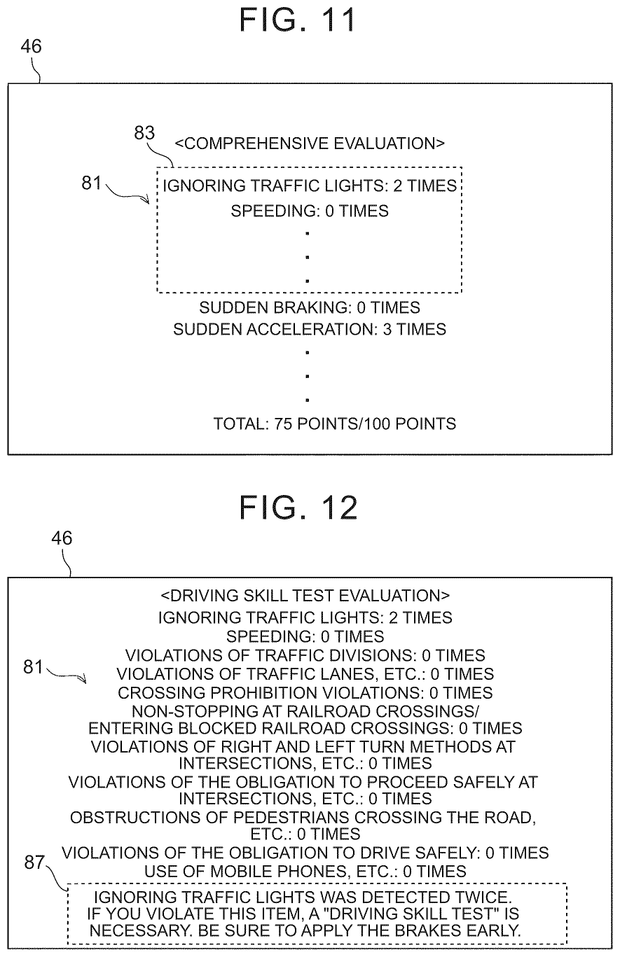

Next, a display example displayed on the display unit 46 of the driver terminal 40 as a result of the display process shown in FIG. 6 being performed by the management server 20 in the second embodiment will be described. The display examples shown in FIGS. 11 and 12 described below are display examples when the CPU 21 has received the notification selection.

FIG. 11 shows a fifth display example displayed on the display unit 46 of the driver terminal 40. When the driving diagnosis app is executed in the driver terminal 40, the CPU 21 of the management server 20 causes the display unit 46 to display the display example shown in FIG. 11 as a home screen that is first displayed after the driving diagnosis app is executed.

In the display example shown in FIG. 11, the message information 81 and the emphasizing frame 83 are displayed. Note that the message information 81 and the emphasizing frame 83 are contents displayed based on the content information transmitted from the management server 20.

As an example, in FIG. 11, “<Comprehensive evaluation> Ignoring traffic lights: 2 times, Speeding: 0 times, . . . Sudden braking: 0 times, Sudden acceleration: 3 times, . . . and Total: 75 points/100 points” are displayed as the message information 81. In this way, the message information 81 shown in FIG. 11 indicates the number of times each item in the plurality of evaluation items has been performed and the comprehensive evaluation for the driving of the specific driver.

As described above, in the second embodiment, the specific evaluation items are ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, and use of mobile phones, etc. As a result, in the display example shown in FIG. 11, as an example of preferentially displaying the specific evaluation item, among the messages indicated by the message information 81, the portion showing the number of times ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, and use of mobile phones, etc. have been performed is surrounded by the emphasizing frame 83. In the display example shown in FIG. 11, the portion of the message indicated by the message information 81 surrounded by the emphasizing frame 83 serves as the test information related to the driving skill test. In FIG. 11, illustration of some evaluation items of the specific evaluation items is omitted, but all the specific evaluation items are actually displayed on the display unit 46, and all the specific evaluation items are preferentially displayed.

FIG. 12 shows a sixth display example displayed on the display unit 46 of the driver terminal 40. The display example shown in FIG. 12 is a home screen that is first displayed after the driving diagnosis app is executed, like the display example shown in FIG. 11, but the content displayed on the home screen is different.

In the display example shown in FIG. 12, the message information 81 and advice information 87 are displayed. Note that the message information 81 and the advice information 87 are contents displayed based on the content information transmitted from the management server 20.

As an example, in FIG. 12, “<Driving skill test evaluation> Ignoring traffic lights: 2 times, Speeding: 0 times, Violations of traffic divisions: 0 times, Violations of traffic lanes, etc.: 0 times, Crossing prohibition violations: 0 times, Non-stopping at railroad crossings/entering blocked railroad crossings: 0 times, Violations of right and left turn methods at intersections, etc.: 0 times, Violations of the obligation to proceed safely at intersections, etc.: 0 times, Obstructions of pedestrians crossing the road, etc.: 0 times, Violations of the obligation to drive safely: 0 times, and Use of mobile phones, etc.: 0 times” are displayed as the message information 81. As described above, in the message information 81 shown in FIG. 12, only the message related to the specific evaluation item is displayed on the display unit 46 as an example of preferentially displaying the specific evaluation item. In addition, the message information 81 indicates the number of times each item in the specific evaluation items has been performed. As a result, the specific driver who saw the message information 81 shown in FIG. 12 can grasp whether the current driving corresponds to driving that can be subject to the driving skill test.

The advice information 87 indicates various advices for particular driving of the specific driver. As an example, in FIG. 12, “Ignoring traffic lights was detected twice. If you violate this item, a “driving skill test” is necessary. Be sure to apply the brakes early.” is displayed as the advice information 87. In this way, the advice information 87 shown in FIG. 12 indicates the driving of the specific driver who can be subject to the driving skill test, and also indicates advice on driving for avoiding the driving skill test.

In the display example shown in FIG. 12, the message indicated by the message information 81 and the advice indicated by the advice information 87 serve as the test information related to the driving skill test.

### Third Embodiment

Next, a third embodiment of the information processing system 10 according to the present embodiment will be described while omitting or simplifying the overlapping portion with the other embodiments. Note that the plurality of evaluation items and the specific evaluation items in the third embodiment are the same as those in the second embodiment.

In the third embodiment, in the case where the driving diagnosis result is displayed on the display unit 46 of the driver terminal 40, even when the reception unit 21C has not received the notification selection, when driving of the specific driver corresponding to a certain violation is detected based on the vehicle information acquired by the acquisition unit 21A, the control unit 21D performs control for preferentially displaying the specific evaluation item over other evaluation items. Specifically, based on the vehicle information acquired by the acquisition unit 21A, when the evaluation unit 21B counts the number of times the specific evaluation item has been performed, the control unit 21D generates content information in which the specific evaluation item is preferentially displayed over other evaluation items among the plurality of evaluation items.

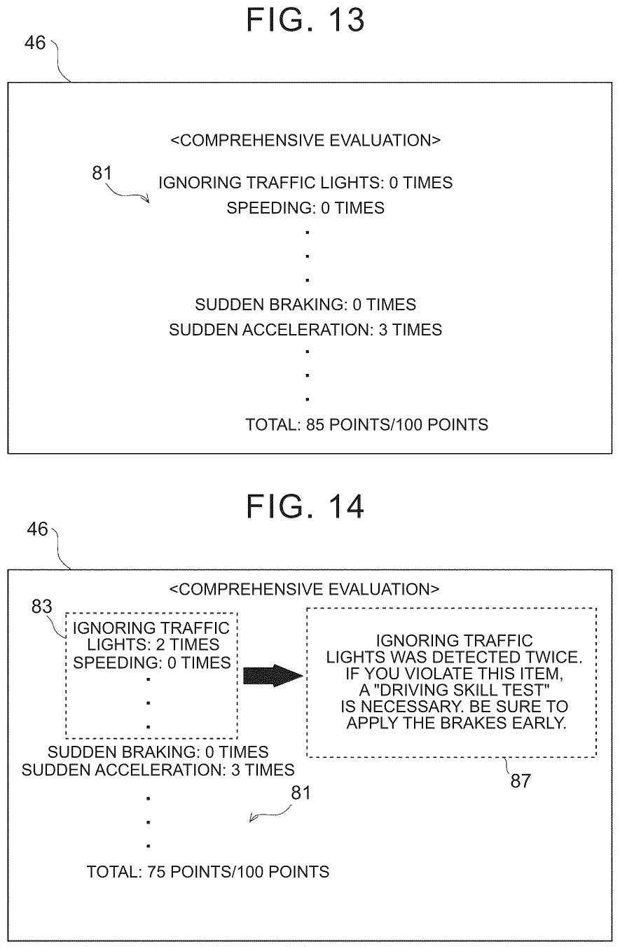

FIG. 13 shows a seventh display example displayed on the display unit 46 of the driver terminal 40. The display example shown in FIG. 13 is the home screen that is first displayed after the driving diagnosis app is executed. The display example shown in FIG. 13 is a display example when the CPU 21 has not received the notification selection.

In the display example shown in FIG. 13, the message information 81 is displayed. As an example, in FIG. 13, “<Comprehensive evaluation> Ignoring traffic lights: 0 times, Speeding: 0 times, . . . Sudden braking: 0 times, Sudden acceleration: 3 times, . . . and Total: 85 points/100 points” are displayed as the message information 81. In FIG. 13, illustration of some evaluation items of the specific evaluation items is omitted, but all the specific evaluation items are actually displayed on the display unit 46, and the number of times all the specific evaluation items have been performed are “0 times”. Note that the message information 81 is content displayed based on the content information transmitted from the management server 20.

As described above, in the display example shown in FIG. 13, the CPU 21 has not received the notification selection, and the number of times all the specific evaluation items have been performed is “0 times”, so that the specific evaluation item is not preferentially displayed over other evaluation items.

FIG. 14 shows an eighth display example displayed on the display unit 46 of the driver terminal 40. The display example shown in FIG. 14 is a home screen that is first displayed after the driving diagnosis app is executed, like the display example shown in FIG. 13, but the content displayed on the home screen is different. The display example shown in FIG. 14 is a display example when the CPU 21 has not received the notification selection, as in the display example shown in FIG. 13.

In the display example shown in FIG. 14, the message information 81, the emphasizing frame 83, and the advice information 87 are displayed. Since the message indicated by the message information 81 shown in FIG. 14 has the same content as the message indicated by the message information 81 shown in FIG. 11, and the advice indicated by the advice information 87 shown in FIG. 14 has the same content as the advice indicated by the advice information 87 shown in FIG. 12, the description thereof is omitted. Note that the message information 81, the emphasizing frame 83, and the advice information 87 are contents displayed based on the content information transmitted from the management server 20.

Here, in the display example shown in FIG. 14, the CPU 21 has not received the notification selection, but the number of times “ignoring traffic lights”, which is the specific evaluation item, has been performed is counted, so that the CPU 21 performs the control for preferentially displaying the specific evaluation item over other evaluation items. Specifically, in the display example shown in FIG. 14, as an example of preferentially displaying the specific evaluation item, among the messages indicated by the message information 81, the portion showing the number of times ignoring traffic lights, violations of traffic divisions, violations of traffic lanes, etc., speeding, crossing prohibition violations, non-stopping at railroad crossings/entering blocked railroad crossings, violations of right and left turn methods at intersections, etc., violations of the obligation to proceed safely at intersections, etc., obstructions of pedestrians crossing the road, etc., violations of the obligation to drive safely, and use of mobile phones, etc. have been performed is surrounded by the emphasizing frame 83. Further, in the display example shown in FIG. 14, as an example of preferentially displaying the specific evaluation item, the advice information 87 is displayed to show the driving of the specific driver who can be subject to the driving skill test as well as advice related to driving to avoid the driving skill test. In the display example shown in FIG. 14, the portion of the message indicated by the message information 81 that is surrounded by the emphasizing frame 83 and the advice indicated by the advice information 87 serve as the test information related to the driving skill test.

As described above, in the management server 20, the specific driver is a driver of a predetermined age, for example, 72 years old or older, and is a so-called elderly driver. In the case where the driving diagnosis result is displayed on the display unit 46 of the driver terminal 40, even when the notification selection has not been received, when driving of the specific driver corresponding to a certain violation is detected based on the acquired vehicle information, the CPU 21 performs control for preferentially displaying the specific evaluation item over other evaluation items. As a result, in the management server 20, the specific evaluation item is preferentially displayed when driving of the specific driver corresponding to a certain violation is detected, thereby allowing the specific driver, who is a driver of a predetermined age or older, to grasp whether the specific driver is performing driving that can be subject to the driving skill test.

### Fourth Embodiment

Next, a fourth embodiment of the information processing system 10 according to the present embodiment will be described while omitting or simplifying the overlapping portion with the other embodiments. Note that a plurality of evaluation items and the specific evaluation items in the fourth embodiment are the same as those in the second embodiment.

In the fourth embodiment, the control unit 21D generates content information indicating content to be displayed as the driving diagnosis result on the monitor 78, more specifically, on a multi-information display (hereinafter referred to as “MID”) 78A of the vehicle 60. In the fourth embodiment, the MID 78A is an example of the “display unit”.

Here, in the case of notifying the specific driver who is driving the vehicle 60 of the driving diagnosis result via the MID 78A, when the reception unit 21C has received the notification selection, the control unit 21D performs control for preferentially notifying the specific driver of the specific evaluation item over other evaluation items as the driving diagnosis result.

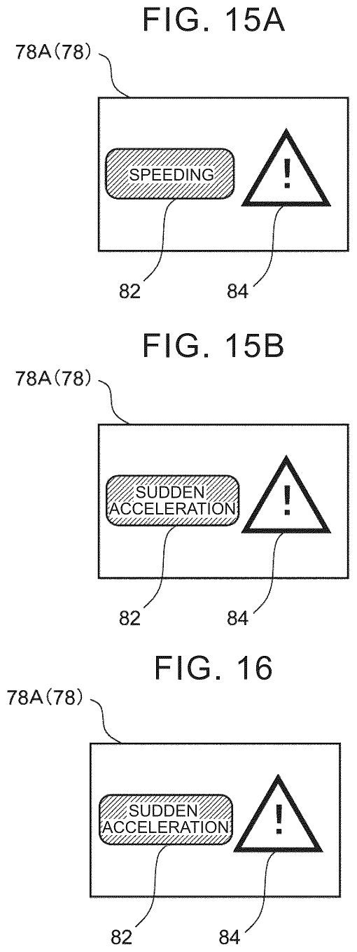

FIGS. 15A and 15B are explanatory diagrams showing display examples on the MID 78A. Specifically, FIG. 15A is a display example when the driving diagnosis result related to the specific evaluation item is displayed on the MID 78A, and FIG. 15B is a display example when the driving diagnosis result related to other evaluation items is displayed on the MID 78A.

As shown in FIGS. 15A and 15B, evaluation item information 82 and evaluation information 84 are displayed on the MID 78A.

The evaluation item information 82 indicates the types of the evaluation item to be notified to the specific driver. As an example, in FIG. 15A, “speeding” is displayed as the evaluation item information 82. In this way, the evaluation item information 82 shown in FIG. 15A indicates that the specific driver is notified of the driving diagnosis result of the specific evaluation item “speeding”. In FIG. 15B, “sudden acceleration” is displayed as the evaluation item information 82. In this way, the evaluation item information 82 shown in FIG. 15B indicates that the specific driver is notified of the driving diagnosis result of the other evaluation item “sudden acceleration”.

The evaluation information 84 visually indicates whether the evaluation item indicated in the evaluation item information 82 is good or bad with an icon. As an example, in FIGS. 15A and 15B, “! (exclamation point)” is displayed in the figure of “A (triangle)” as the evaluation information 84. Thus, the evaluation information 84 shown in FIG. 15A indicates that a bad result was given for the specific evaluation item “speeding” to the specific driver. The evaluation information 84 shown in FIG. 15B indicates that a bad result was given for the other evaluation item “sudden acceleration” to the specific driver.

Note that the evaluation items displayed in the evaluation item information 82 are not limited to speeding and sudden acceleration, and also include evaluation items such as ignoring traffic lights, violations of traffic divisions, sudden braking, and sudden steering, etc. In addition, the icon displayed in the evaluation information 84 is not limited to the one in which the “! (exclamation mark)” is displayed in the figure of “Δ (triangle)”, and bad results may be displayed by different icons. Furthermore, the evaluation information 84 includes icons indicating good results in addition to icons indicating bad results.

FIG. 16 is a first display example displayed on the MID 78A during driving of the vehicle 60. The display example shown in FIG. 16 is a display example when the CPU 21 has not received the notification selection.

Here, it is assumed that the CPU 21 has detected driving of the specific driver corresponding to sudden acceleration and speeding among the plurality of evaluation items based on the acquired vehicle information. In this case, since the CPU 21 has not received the notification selection, the CPU 21 causes the MID 78A to display “sudden acceleration” as the evaluation item information 82 as shown in FIG. 16. The CPU 21 causes the MID 78A to display an icon in which the “! (exclamation mark)” is displayed in the figure of “Δ (triangle)” as the evaluation information 84.

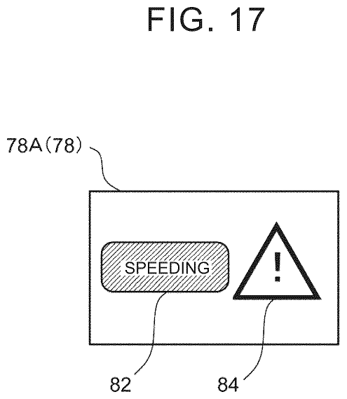

FIG. 17 is a second display example displayed on the MID 78A during driving of the vehicle 60. The display example shown in FIG. 16 is a display example when the CPU 21 has received the notification selection.

Here, similar to the above, it is assumed that the CPU 21 has detected driving of the specific driver corresponding to sudden acceleration and speeding among the plurality of evaluation items based on the acquired vehicle information. In this case, since the CPU 21 has received the notification selection, the CPU 21 causes the MID 78A to display “speeding” as the evaluation item information 82 as shown in FIG. 17. The CPU 21 causes the MID 78A to display an icon in which the “! (exclamation mark)” is displayed in the figure of “Δ (triangle)” as the evaluation information 84. In the display example shown in FIG. 17, the evaluation item information 82 displaying “speeding” and the evaluation information 84 indicating whether the result of the evaluation item shown in the evaluation item information 82 is good or bad serve as the test information related to the driving skill test.

As described above, in the management server 20, in the case of notifying the specific driver who is driving the vehicle 60 of the driving diagnosis result via the MID 78A, when the notification selection has been received, the CPU 21 performs control for preferentially notifying the specific driver of the specific evaluation item over other evaluation items as the driving diagnosis result. Accordingly, the management server 20 preferentially notifies the specific driver who is driving the vehicle 60 of the specific evaluation item over other evaluation items, thereby allowing the specific driver who is driving to grasp whether the specific driver is performing driving that can be subject to the driving skill test.

### Fifth Embodiment

Next, a fifth embodiment of the information processing system 10 according to the present embodiment will be described while omitting or simplifying the overlapping portion with the other embodiments. Note that the plurality of evaluation items and the specific evaluation items in the fifth embodiment are the same as those in the second embodiment.

In the fifth embodiment, in the case of notifying the specific driver who is driving the vehicle 60 of the driving diagnosis result, even when the reception unit 21C has not received the notification selection, when driving of the specific driver corresponding to a certain violation is detected based on the vehicle information acquired by the acquisition unit 21A, the control unit 21D performs control for preferentially notifying the specific driver of the specific evaluation item over other evaluation items as the driving diagnosis result. Specifically, based on the vehicle information acquired by the acquisition unit 21A, when the evaluation unit 21B counts the number of times the specific evaluation item has been performed, the control unit 21D generates content information in which the specific evaluation item is preferentially displayed over other evaluation items among the plurality of evaluation items.

Here, it is assumed that the CPU 21 has detected driving of the specific driver corresponding to sudden acceleration and speeding among the plurality of evaluation items based on the acquired vehicle information. In this case, although the CPU 21 has not received the notification selection, since driving of the specific driver corresponding to a certain violation is detected, the CPU 21 causes the MID 78A to display “sudden acceleration” as the evaluation item information 82 as shown in FIG. 16. The CPU 21 causes the MID 78A to display an icon in which the “! (exclamation mark)” is displayed in the figure of “Δ (triangle)” as the evaluation information 84.

As described above, in the management server 20, the specific driver is a driver of a predetermined age, for example, 72 years old or older, and is a so-called elderly driver. In the case of notifying the specific driver who is driving the vehicle 60 of the driving diagnosis result, even when the notification selection has not been received, when driving of the specific driver corresponding to a certain violation is detected based on the acquired vehicle information, the CPU 21 performs control for preferentially notifying the specific driver of the specific evaluation item over other evaluation items as the driving diagnosis result. Accordingly, in the management server 20, the specific evaluation item is preferentially notified to the specific driver who is driving the vehicle 60 when driving by the specific driver corresponding to a certain violation is detected, thereby allowing the specific driver who is a driver of a predetermined age or older to grasp whether the specific driver is performing driving that can be subject to the driving skill test during driving of the vehicle 60.

Others

In the above-described embodiments, the management server 20 is used an example of the information processing device. However, the present disclosure is not limited to this, and the on-board device 15 mounted on the vehicle 60 may be used as an example of the information processing device, and a combination of the management server 20 and the on-board device 15 may be used as an example of the information processing device. When the combination of the management server 20 and the on-board device 15 is used as an example of the information processing device, at least part of each functional configuration of the CPU 21 of the management server 20 shown in FIG. 4 may be performed by the CPU 61 of the on-board device 15 shown in FIG. 5. In this case, the display process shown in FIG. 6 is executed by one processor of the CPU 21 of the management server 20 or the CPU 61 of the on-board device 15, or by a combination of multiple processors of the CPU 21 of the management server 20 and the CPU 61 of the on-board device 15.

In the above-described embodiments, the specific driver is a so-called elderly driver of a predetermined age of 72 years old or older and whose driving skill is declining. However, the predetermined age is not limited to 72, and may be 70, 75, or any other age, as long as it is an age that can be subject to the driving skill test.

In the above-described embodiments, the MID 78A of the monitor 78 of the vehicle 60 is used as an example of the “display unit”, but other monitors 78 such as a head-up display may be used as an example of the “display unit”. Also, both the display unit 46 of the driver terminal 40 and the monitor 78 of the vehicle 60 may be examples of the “display unit”.

In the above-described embodiments, the screen of the electronic device such as the display unit 46 of the driver terminal 40 or the monitor 78 of the vehicle 60 is used as an example of the “display unit”. However, instead of or in addition to this, a recording medium such as paper may be used as an example of the “display unit”, and the driving diagnosis result of the specific driver may be printed and displayed on the recording medium.

In the above-described embodiments, the notification of the driving diagnosis result to the specific driver who is driving the vehicle 60 is displayed on the MID 78A. However, instead of or in addition to this, the notification may be output by voice from the speaker 79.

In the above-described embodiments, information of notifying the test information to the specific driver is received when a predetermined operation is performed on the driving diagnosis app. However, instead of or in addition to this, when the age of the driver such as the specified driver is registered in the information processing system 10 and the registered age is equal to or older than the predetermined age, the CPU 21 may receive the information of notifying the test information to the specific driver without accompanying the above predetermined operation.

It should be noted that various processors other than the CPU may execute the display process that is executed when the CPU 21 reads the software (program) in the above embodiments. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, the display process may be executed by one of these various processors, or a combination of two or more processors of the same type or different types (for example, a combination of FPGAs, a combination of a CPU and an FPGA, and the like). Further, the hardware structure of these various processors is, more specifically, an electric circuit in which circuit elements such as semiconductor elements are combined.

Further, in the above-described embodiments, the mode in which the information processing program 24A is stored (installed) in the storage unit 24 in advance has been described, but the present disclosure is not limited to this. The information processing program 24A may be stored in a storage medium such as a compact disc read-only memory (CD-ROM), a digital versatile disc read-only memory (DVD-ROM), and a universal serial bus (USB) memory to be provided. Further, the information processing program 24A may be downloaded from an external device via the network N.

What is claimed is:

1. An information processing device comprising:
an acquisition unit that acquires vehicle information related to a vehicle;
an evaluation unit that performs evaluation related to driving of a specific driver based on the vehicle information acquired by the acquisition unit and whether a plurality of evaluation items is good or bad, the specific driver being a driver of the vehicle and being able to be subject to a predetermined test regarding driving skills that is conducted by a predetermined organization;
a reception unit that receives a selection as to whether to notify the specific driver of test information regarding the predetermined test; and
a control unit that performs control for preferentially displaying a specific evaluation item related to a determination item as to whether the specific driver is to be subject to the predetermined test over another evaluation item other than the specific evaluation item among the plurality of evaluation items, when a result of the evaluation by the evaluation unit is displayed on a display unit and the reception unit has received a notification selection for notifying the specific driver of the test information.

2. The information processing device according to claim 1, wherein when the specific driver who is driving the vehicle is notified of the result of the evaluation by the evaluation unit and the reception unit has received the notification selection, the control unit performs control for preferentially notifying the specific driver of the specific evaluation item over the other evaluation item as the result of the evaluation.

3. The information processing device according to claim 1, wherein
the specific driver is a driver of a predetermined age or older, and
in a case where the display unit displays the result of the evaluation by the evaluation unit, even when the reception unit has not received the notification selection, when driving of the specific driver corresponding to the determination item is detected based on the vehicle information acquired by the acquisition unit, the control unit performs control for preferentially displaying the specific evaluation item over the other evaluation item.

4. The information processing device according to claim 1, wherein
the specific driver is a driver of a predetermined age or older, and
in a case where the specific driver who is driving the vehicle is notified of the result of the evaluation by the evaluation unit, even when the reception unit has not received the notification selection, when driving of the specific driver corresponding to the determination item is detected based on the vehicle information acquired by the acquisition unit, the control unit performs control for preferentially notifying the specific driver of the specific evaluation item over the other evaluation item as the result of the evaluation.

5. An information processing method in which a computer executes processes comprising:
acquiring vehicle information related to a vehicle;
performing evaluation related to driving of a specific driver based on the acquired vehicle information and whether a plurality of evaluation items is good or bad, the specific driver being a driver of the vehicle and being able to be subject to a predetermined test regarding driving skills that is conducted by a predetermined organization;
receiving a selection as to whether to notify the specific driver of test information regarding the predetermined test; and
performing control for preferentially displaying a specific evaluation item related to a determination item as to whether the specific driver is to be subject to the predetermined test over another evaluation item other than the specific evaluation item among the plurality of evaluation items, when a result of the evaluation is displayed on a display unit and a notification selection for notifying the specific driver of the test information has been received.

6. A non-transitory storage medium storing an information processing program that causes a computer to execute processes comprising:
acquiring vehicle information related to a vehicle;
performing evaluation related to driving of a specific driver based on the acquired vehicle information and whether a plurality of evaluation items is good or bad, the specific driver being a driver of the vehicle and being able to be subject to a predetermined test regarding driving skills that is conducted by a predetermined organization;
receiving a selection as to whether to notify the specific driver of test information regarding the predetermined test; and
performing control for preferentially displaying a specific evaluation item related to a determination item as to whether the specific driver is to be subject to the predetermined test over another evaluation item other than the specific evaluation item among the plurality of evaluation items, when a result of the evaluation is displayed on a display unit and a notification selection for notifying the specific driver of the test information has been received.
